(19) United States
(12) Patent Application Publication
(10) Pub. No.: US 2025/0356469 A1
(43) Pub. Date: Nov. 20, 2025

(54) INPAINTING METHOD AND INPAINTING APPARATUS

(71) Applicant: Smarter Silicon (Shanghai) Technologies Co., Ltd., Shanghai (CN)

(72) Inventor: Chia Chi HUANG, Shanghai (CN)

(21) Appl. No.: 19/287,869

(22) Filed: Aug. 1, 2025

Related U.S. Application Data
(63) Continuation of application No. PCT/CN2023/138325, filed on Dec. 13, 2023.

(30) Foreign Application Priority Data
Feb. 2, 2023 (CN) 202310087479.6

(51) Int. Cl. G06T 5/77; G06T 5/60

(52) U.S. Cl. CPC G06T 5/77; G06T 5/60; G06T 2207/20084

(57) ABSTRACT

An inpainting method includes obtaining parameter information and pixel information of a to-be-inpainted image and performing inpainting processing on the to-be-inpainted image based on the parameter information and the pixel information to obtain an inpainted image. The parameter information characterizes an attribute of the to-be-inpainted image.

### CROSS-REFERENCE TO RELATED APPLICATIONS

This application is a continuation of International Application No. PCT/CN2023/138325, filed on Dec. 13, 2023, which claims priority to Chinese Patent Application No. 202310087479.6, filed on Feb. 2, 2023, the entire contents of both of which are incorporated herein by reference.

### TECHNICAL FIELD

The present disclosure relates to the image processing technology field and, more particularly, to an inpainting method and an inpainting apparatus.

### BACKGROUND

Automatic image inpainting refers to a process of reconstructing parts of an image or a video that are missing or damaged. The technology is widely used. For example, image inpainting is used against illegal activities or to restore cultural artifacts. In the digital world, image inpainting is also referred to as image interpolation or video interpolation, which uses an appropriate algorithm to replace the image data that is missing or damaged, for example, a small area and a defect in a to-be-inpainted image to cause the to-be-inpainted image to achieve an ideal art effect. The existing image inpainting technology adopts an inpainting method of deep learning, which uses the image pixels to perform inpainting on the to-be-inpainted image. However, the inpainting effect of the inpainting method is not ideal.

### SUMMARY

An aspect of the present disclosure provides an inpainting method. The method includes obtaining parameter information and pixel information of a to-be-inpainted image and performing inpainting processing on the to-be-inpainted image based on the parameter information and the pixel information to obtain an inpainted image. The parameter information characterizes an attribute of the to-be-inpainted image.

An aspect of the present disclosure provides an electronic device, including a processor and a memory. The memory stores executable instructions that, when executed by the processor, cause the processor to obtain parameter information and pixel information of a to-be-inpainted image and perform inpainting processing on the to-be-inpainted image based on the parameter information and the pixel information to obtain an inpainted image. The parameter information characterizes an attribute of the to-be-inpainted image.

An aspect of the present disclosure provides a computer-readable storage medium storing executable instructions that, when executed by the processor, cause the processor to obtain parameter information and pixel information of a to-be-inpainted image and perform inpainting processing on the to-be-inpainted image based on the parameter information and the pixel information to obtain an inpainted image. The parameter information characterizes an attribute of the to-be-inpainted image.

### BRIEF DESCRIPTION OF THE DRAWINGS

FIG. 1 illustrates a schematic flowchart of an inpainting method according to some embodiments of the present disclosure.

FIG. 2 illustrates a schematic flowchart of an inpainting method according to some embodiments of the present disclosure.

FIG. 3 illustrates a schematic diagram of pixel information normalization according to some embodiments of the present disclosure closure.

FIG. 4 illustrates a schematic diagram of pixel information normalization according to some embodiments of the present disclosure closure.

FIG. 5 illustrates a schematic diagram of extracting a parameter feature vector according to some embodiments of the present disclosure.

FIG. 6 illustrates a schematic diagram of a first inpainting process according to some embodiments of the present disclosure.

FIG. 7 illustrates a schematic diagram of a block of first inpainting image data according to some embodiments of the present disclosure.

FIG. 8 illustrates a schematic diagram of an image inpainting process according to some embodiments of the present disclosure.

FIG. 9 illustrates a schematic diagram of an inpainting process of a first image block according to some embodiments of the present disclosure.

FIG. 10 illustrates a schematic diagram of an inpainting process of a video file according to some embodiments of the present disclosure.

FIG. 11 illustrates a schematic structural diagram of an inpainting apparatus according to some embodiments of the present disclosure.

### DETAILED DESCRIPTION OF THE EMBODIMENTS

In a process of implementing the technical solution of the present disclosure, the inventors find that in the existing image inpainting technology, since setting parameters of an image collection device and a hardware device (e.g., a camera) for collecting an image are different, the image quality of the collected image can be affected differently. For example, shutter speed can affect motion blur, aperture size can affect brightness, and sensitivity can affect image noise, etc. Currently, when the image inpainting method is performed on an image, image pixels can be used to perform inpainting without considering the impact of the setting parameters of the hardware device, which causes the image effect is not ideal after inpainting.

To address the above problem, embodiments of the present disclosure are provided. To describe the purpose, technical solution, and advantages of embodiments of the present disclosure clearer, embodiments of the present disclosure are described in detail in connection with the accompanying drawings. Embodiments of the present disclosure are intended to explain and describe the general idea of the present disclosure and should not be considered to limit embodiments of the present disclosure. In the specification and accompanying drawings, same or similar accompanying drawing signs can refer to same or similar members or components. The accompanying drawings may not be drawn according to a certain ratio for clarity. Some well-known members or structures can be ignored in the accompanying drawings.

The technical solution of the present disclosure is described in detail below in connection with the accompanying drawings.

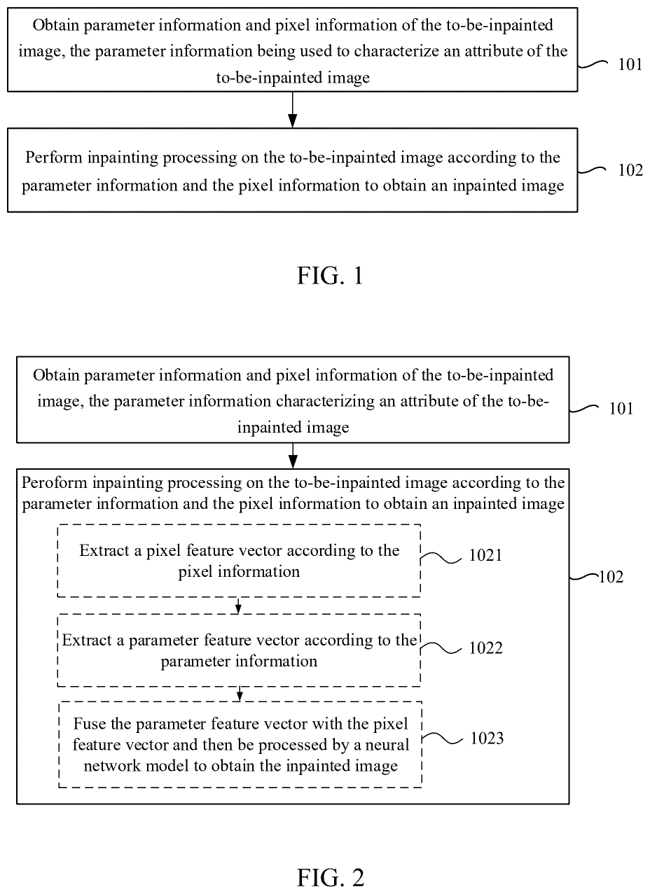

FIG. 1 illustrates a schematic flowchart of an inpainting method according to some embodiments of the present disclosure. The inpainting method includes the following steps.

At 101, parameter information and pixel information of the to-be-inpainted image are obtained. The parameter information is used to characterize an attribute of the to-be-inpainted image.

The to-be-inpainted image of embodiments of the present disclosure can be a single image or a single frame image of a video file. For the single image, the inpainting can be directly performed on the single image through the inpainting method of embodiments of the present disclosure. For the video file, a to-be-inpainted image of each frame needs to be obtained after the video file is divided into frames. Then, the inpainting can be performed on the to-be-inpainted image of each frame in the inpainting method of embodiments of the present disclosure.

The parameter information can include an exposure time length (ExposureTime), aperture value (Fnumber), sensitivity (ISO speed ratings), a compression ratio (Compressed Bits per Pixel), a shutter speed, a brightness value, exposure compensation (Exposure Bias Value), manufacturer, model number, shooting date and time, etc. The parameter information can be the configuration file record of the image collection device during the image shooting process, such as the information recorded in the Exchangeable Image File Format (EXIF). In some other embodiments, the parameter information can also include information recorded in other files that characterizes the attributes of the to-be-inpainted image.

For video files, in addition to the above information related to the shooting parameters of the image collection device, the parameter information can also include a bit rate, a frame rate, and a resolution of a video stream.

A pixel is a most basic unit that forms a digital image and can be understood as a small square in the image having color information. In embodiments of the present disclosure, the pixel information can characterize a numerical value corresponding to color information of each small square in the to-be-inpainted image.

Inpainting operation of embodiments of the present disclosure can include deblurring, denoising, super-resolution, deraining, etc. Images collected by image collection devices with different parameter information can have unique attributes. That is, when the parameter information settings of the image collection devices are different, the attributes of the collected to-be-inpainted images can be different.

At 102, inpainting is performed on the to-be-inpainted image according to the parameter information and the pixel information to obtain an inpainted image.

In the inpainting method of the present disclosure, the inpainting can be performed on the to-be-inpainted image using the parameter information and the pixel information of the t-be-inpainted image to obtain the inpainted image. Thus, in the inpainting process, the pixel information and the parameter information of the to-be-inpainted image can be used simultaneously to cause the inpainted image to have a better inpainting effect.

Step 102 is described in detail in some other embodiments of the present disclosure. FIG. 2 illustrates a schematic flowchart of an inpainting method according to some embodiments of the present disclosure. Step 102 is described in detail in connection with FIG. 2.

At 1021, a pixel feature vector is extracted according to the pixel information.

At 1022, a parameter feature vector is extracted according to the parameter information.

At 1023, the parameter feature vector is fused with the pixel feature vector and then be processed by a neural network model to obtain the inpainted image.

In some embodiments of the present disclosure, the pixel feature vector and parameter feature vector can be fused and then input into a pre-trained neural network model for inpainting, resulting in obtaining the inpainted image. The inpainting based on the neural network model can reduce data computations and simplify the inpainting process. Inpainting according to the pixel feature vector and the parameter feature vector can improve the image inpainting effect.

Corresponding to step 1021 and step 1022, extracting the pixel feature vector according to the pixel information and extracting the parameter feature vector according to the parameter information can include normalizing the pixel information and parameter information to obtain normalized pixel information and normalized parameter information, obtaining the pixel feature vector according to the normalized pixel information, and obtaining the parameter feature vector according to the normalized parameter information.

Normalization can refer to processing the data that needs to be processed (through a certain algorithm) and limiting the processed data within a certain range, e.g., (0, 1) or (−1, −). In the present disclosure, the normalization processing range can be determined to be (0, 1).

In embodiments of the present disclosure, the pixel information and the parameter information can be normalized to control values of the pixel information and the parameter information within a certain range to reduce data volume, cause the data processing to be more convenient, simplify the calculation process, and improve the calculation efficiency.

In some embodiments, a linear normalization method can be applied to normalize the pixel information and the parameter information. The linear normalization method is described in Formula (1).

$${x}_{n e w} = \frac{x - {x}_{min}}{{x}_{max} - {x}_{min}} \qquad ( 1 )$$

For the pixel information, x_{new} is a normalized pixel value, xₘₐₓ and xₘᵢₙ are the industry-defined maximum pixel value and the minimum pixel value (the maximum pixel value is 255, and the minimum pixel value is 0), and x is an actual pixel value of a pixel in the to-be-inpainted image. For example, the actual pixel value can be 128, and the normalized value of the actual pixel value can be calculated as (128−0)/(255−0)=0.5.

For a parameter object in the parameter information, x_{new} is a normalized parameter value, and xₘₐₓ and xₘᵢₙ are the industry-defined maximum and minimum values for the parameter object. For example, an effective range of the exposure time for the image collection device, such as exposure time of a camera, can be typically 1/250 to 1 second. Therefore, the maximum value for the exposure time can be set to 1, and the minimum value for the exposure time can be set to 1/250. x represents the actual parameter value of a parameter in the to-be-inpainted image.

In some other embodiments, other methods can be used to perform the normalization, such as a zero-mean normalization method and a decimal scaling normalization. The zero-mean normalization method can also be referred to as the standard deviation normalization, which is a commonly used normalization method. The mean of the data after being processed in the zero-mean normalization method can be zero, and the standard deviation can be 1. The decimal scaling normalization can include moving the decimal point of the actual numerical value to map the actual numerical value to (−1, 1). In some embodiments, an appropriate normalization method can be selected according to actual needs, which is not limited in embodiments of the present disclosure.

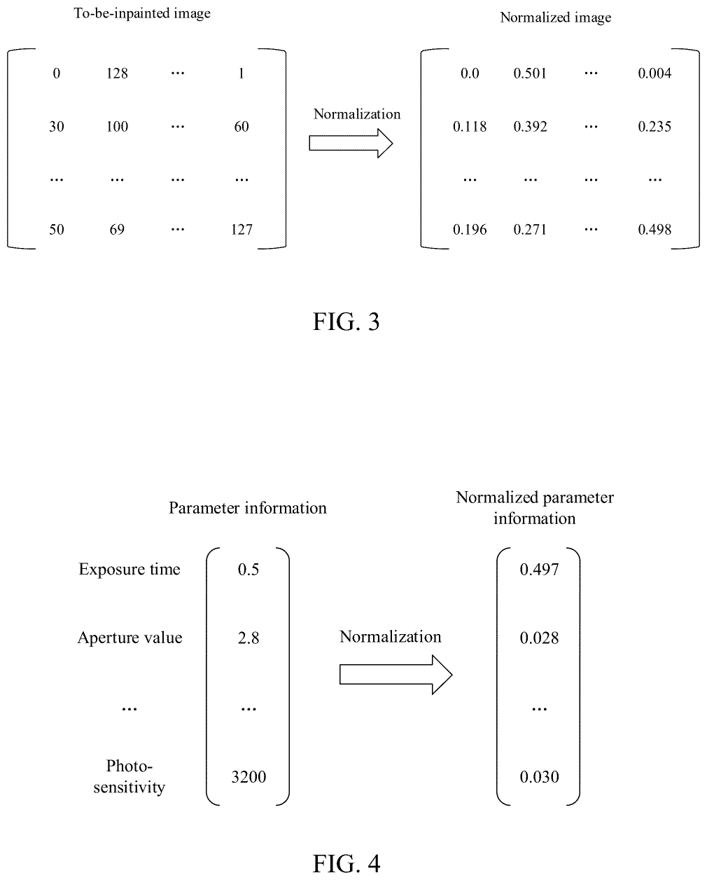

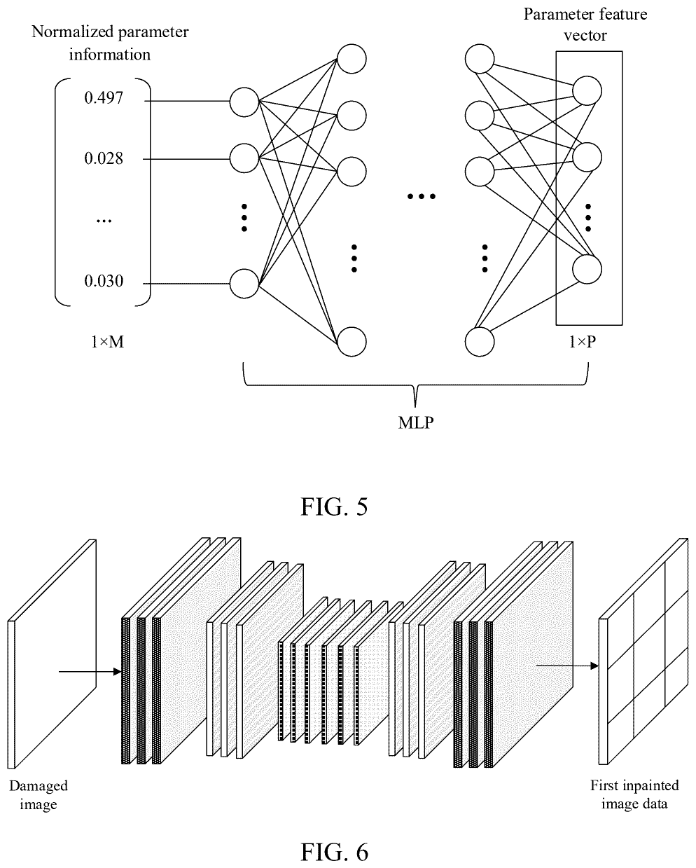

To better understand the processes of performing the normalization on the pixel information and the parameter information, refer to FIG. 3 and FIG. 4. FIG. 3 illustrates a schematic diagram of the pixel information normalization according to some embodiments of the present disclosure closure. FIG. 4 illustrates a schematic diagram of the pixel information normalization according to some embodiments of the present disclosure closure.

As shown in FIG. 3, after normalizing the pixel value of each pixel in the to-be-inpainted image, for example, calculating using Formula (1), a normalized image is obtained. In some embodiments, the normalized image can be inferred through a pre-trained neural network model configured for image inpainting, such as a convolutional neural network (CNN), to obtain a preliminary inpainted image. Based on the preliminary inpainted image, the pixel feature vector corresponding to the pixel information can be obtained. The process of obtaining the pixel feature vector can be explained in detail below.

As shown in FIG. 4, after the normalization calculation is performed on each parameter included in the parameter information of the to-be-inpainted image, a value of each parameter after the normalization is obtained. That is, the parameter information after the normalization is obtained. In some embodiments, values obtained after normalizing each parameter can form a first dimension vector, which can be inferred by the neural network model, e.g., a multilayer perceptron (MLP) model. That is, the first dimension parameter feature vector corresponding to the parameter information can be obtained.

To better understand the process of obtaining the parameter feature vector, refer to FIG. 5. FIG. 5 illustrates a schematic diagram of extracting the parameter feature vector according to some embodiments of the present disclosure. The normalized value of each parameter is written into a vector as an input to the neural network model. The neural network model shown in FIG. 5 is a multilayer perceptron model. A one-dimensional normalized vector with a size of 1*M can be input into the multilayer perceptron model, where M denotes a number of parameters. A one-dimensional parameter feature vector with a size of 1*P can be obtained after the inference of the multilayer perceptron model, where P denotes a number of parameter features.

In some embodiments, in step 1021, extracting the pixel feature vectors according to the pixel information can include performing first inpainting on the to-be-inpainted image based on the pixel information of the to-be-inpainted image to obtain first inpainted image data, dividing the first inpainted image data into a plurality of first image blocks with the same size according to a spatial position, and extracting the pixel feature vector of each of the first image blocks.

In embodiments of the present disclosure, when performing block division, the first inpainted image data can be divided according to actual needs. For example, the first inpainted image data can be divided into the plurality of first image blocks with the same size according to the numbers of the column and the row of the first inpainted image data. In some other embodiments, the first inpainted image data can be divided into the plurality of first image blocks with different sizes to facilitate calculation according to other determined rules.

By dividing the first inpainted image data and then extracting the pixel feature vector of each first image block, the image can be inpainted based on the pixel feature vector of each first image block in the subsequent inpainting process, which ensures the entirety for the inpainting and improves the overall inpainting effect. Moreover, the inpainting can be performed block by block, which reduces the calculation amount for inpainting each image block and reduces the hardware computation load.

In some other embodiments, the block division may not be performed. For example, when the image size is small, pixel feature vectors can be directly extracted from the entire first inpainted image data.

FIG. 6 illustrates a schematic diagram of the first inpainting process according to some embodiments of the present disclosure. The first inpainting process is described based on FIG. 6.

The first inpainting process can include, after normalizing the pixel information of the to-be-inpainted image, obtaining the normalized image. Since the normalization processing can be only performed on the pixel value, the relative relationship among the pixel values may not be changed. Thus, the normalized image can still be a damaged image that is to be inpainted. The damaged image can be input to the neural network model for inference. The neural network model shown in FIG. 6 is a convolutional neural network model. The first inpainted image data can be obtained after the model inference. Then, the first inpainted image data can be divided into blocks. For example, the first inpainted image data can be divided into the plurality of first image blocks with the same size according to the spatial position of the to-be-inpainted image, and the pixel feature vector of each first image block can be extracted.

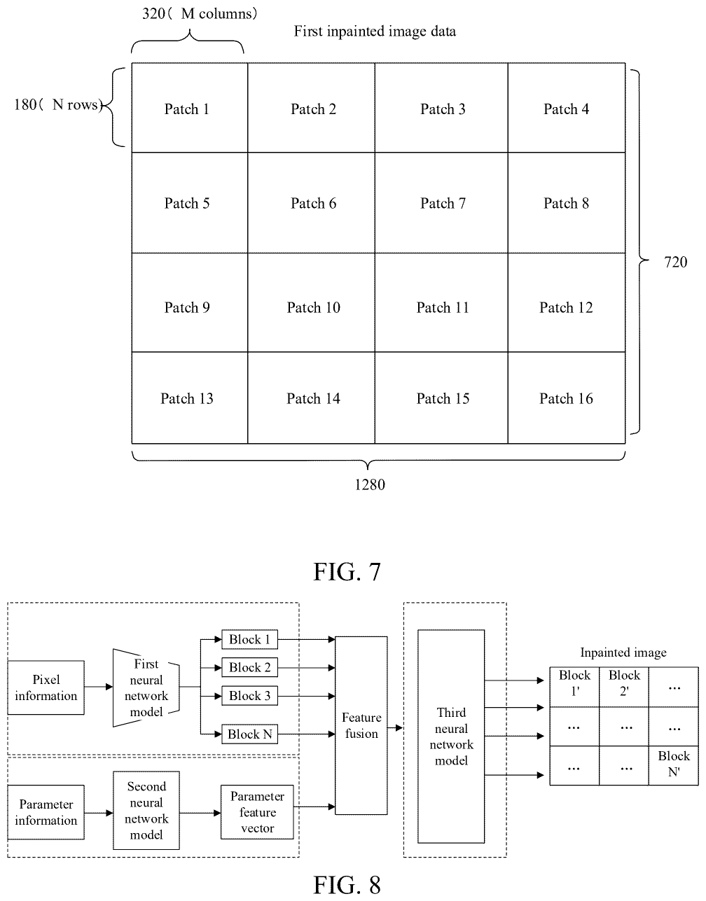

To better understand the block division process, refer to FIG. 7. FIG. 7 illustrates a schematic diagram of block division of the first inpainting image data according to some embodiments of the present disclosure.

In some embodiments, assume that the resolution of the damaged image input to the neural network model is 1280*720. The damaged image can include three channels, red, green, and blue. When performing the model inference, the number of samples selected for one time training can be 1. That is, the batch size is 1. An input of the neural network model (e.g. CNN) can be a four-dimensional tensor with a size of 1*3*720*1280. The output of the neural network model can also be a four-dimensional tensor with a size of 1*3*720*1280. To facilitate the subsequent inpainting operation, the first inpainted image data can be divided into blocks. Then, the pixel feature vector of each first image block can be extracted to inpaint the image. In some embodiments, the block division method can include uniformly dividing the first inpainting data based on the spatial positions according to the length and width of the first inpainted image. As shown in FIG. 7, for example, the first inpainted image data is divided into 16 first image blocks (patch 1 to patch 16) with the same size. The block division method can also include dividing the first inpainted image data into a plurality of first image blocks with different sizes according to the actual needs. To facilitate distinguishing the blocks, each first image block can be numbered according to the sequence. For example, numbers 1 to 16 are marked in FIG. 7.

The pixel feature vector corresponding to the first image block obtained through block division can be multi-dimensional. The multidimensional pixel feature vector can be understood as a matrix with N rows and M columns of pixels in each block formed by the pixels included in the first image block. In some embodiments, the process of extracting the pixel feature vector for each first image block can include obtaining the matrix with the N rows and the M columns formed by the feature pixels corresponding to the first image block,

In some embodiments, in step 1023, the fused parameter feature vector and the pixel feature vector can be processed by the neural network model to obtain the inpainted image can include fusing the pixel feature vector of each first image block with the parameter feature vector to obtain a fused feature vector corresponding to each first image block, processing each fused feature vector by the neural network model to obtain a plurality of second image blocks corresponding to the plurality of first image blocks, and obtaining the inpainted image based on the plurality of second image blocks.

In embodiments of the present disclosure, the pixel feature vector corresponding to each first image block can be fused with the parameter feature vector to obtain the fused feature vector corresponding to each first image block. Then, each first image block can be inpainted through the neural network model based on the fused feature vector. By inpainting through the neural network model, the inpainting efficiency can be improved. By performing the inpainting block by block, each part of the to-be-inpainted image can be inpainted to ensure the entirety of the inpainting. The inpainting effect can be improved by sufficiently considering the pixel information and the parameter information during inpainting.

Vector fusion is a process of fusing at least two vectors into one vector. During fusion, the dimensions of the two vectors should be the same. The vector fusion process can include a plurality of forms, for example, including one or more of connections of two vectors, interpolation of one vector into another vector, and multiplication or addition of two vectors. The connection of the vectors can include the following process. Assume that two one-dimensional vectors can be [1, 2, 3, 4] and [5, 6], the connection of the vectors can generate a one-dimensional fused vector [1, 2, 3, 4, 5, 6] with a size of 1*6. The addition of the vectors can be an addition method performed element by element, which requires that the two vectors have the same dimension. Then, the addition can be performed element by element. When the fusion method is more complex, the calculation speed can be slower, and the inpainting effect can be better. Thus, in some embodiments, the calculation speed and the inpainting effect may need to be considered simultaneously to select the appropriate fusion method.

In some embodiments, the pixel feature vector corresponding to each first image block can be a multidimensional vector, for example, a two-dimensional or three-dimensional vector. Before fusing the pixel feature vector corresponding to each first image block with the parameter feature vector, the method can also include rearranging each of the pixel feature vectors to obtain a one-dimensional vector of each first image block with the same dimension as the parameter feature vector.

The above process can include unifying the dimensions of the two vectors before fusing the pixel feature vector and the parameter feature vector. Since the parameter feature vector is a one-dimensional feature vector, the multi-dimensional vector corresponding to the first image block may need to be rearranged to obtain a one-dimensional vector. The rearrangement process can include rearranging the matrix with N rows and M columns formed by the pixels included in the first image block into a matrix with one row or one column to obtain the one-dimensional vector.

To better understand the rearrangement process, the description can be made to the following example. For example, Matrix (1) is a 2×2 matrix, and Matrix (2) is a matrix with one row and 4 columns of size 1*4 obtained by rearranging Matrix (1).

$$[ \begin{matrix}x 1 & x 2 \\ x 3 & x 4\end{matrix} ] \qquad ( 1 )$$

$$[ \begin{matrix}x 1 & x 2 & x 3 & x 4\end{matrix} ] \qquad ( 2 )$$

To better understand the above feature vector fusion process, refer to FIG. 8. FIG. 8 illustrates a schematic diagram of an image inpainting process according to some embodiments of the present disclosure. As shown in FIG. 8, in embodiments of the present disclosure, during image inpainting, on one aspect, based on the above method, the pixel information is normalized and then input to the first neural network model. The first neural network model shown in FIG. 8 can be a CNN network model. The CNN network model can output the first inpainted image data, which can be divided into a plurality of first image blocks. FIG. 8 shows block 1 to block N. Each first image block can be processed to obtain the pixel feature vector corresponding to each first image block. In some embodiments, the pixel feature vector corresponding to each first image block can be obtained as described above.

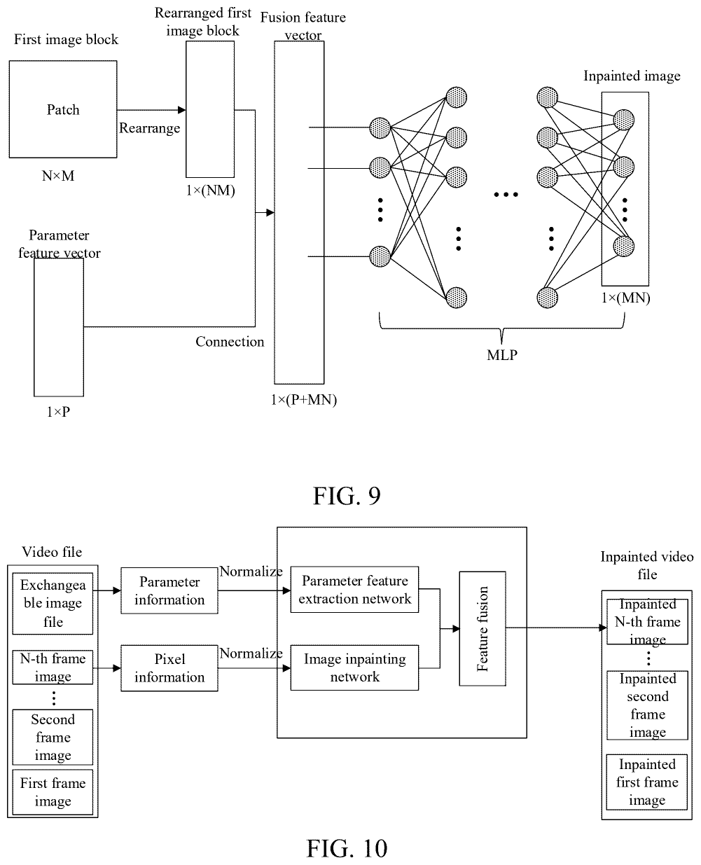

On another aspect, the parameter information is normalized and then input into the second neural network model based on the above method. The second neural network model shown in FIG. 8 is an MLP network model. The MLP network model can output the parameter feature vector corresponding to the parameter information. During feature fusion, each pixel feature vector corresponding to each first image block can be fused with the parameter feature vector to obtain a fused feature vector corresponding to each first image block. Then, each fused feature vector is processed by the third neural network model shown in FIG. 8 to obtain a plurality of second image blocks. FIG. 8 shows block 1′ to block N′ corresponding to block 1 to block N after inpainting. The inpainted image can be formed based on the plurality of second image blocks. The third neural network model can be an MLP network model with N layers, where N is determined according to actual processing. To facilitate the understanding of the inpainting process of step 1023, refer to FIG. 9. FIG. 9 illustrates a schematic diagram of an inpainting process of a first image block according to some embodiments of the present disclosure.

FIG. 9 illustrates the inpainting process of a certain first image block. As shown in FIG. 9, the first image block with a dimension of N*M is converted into a one-dimensional vector of size 1*(NM). The one-dimensional vector represents the pixel feature vector obtained after flattening the multidimensional pixel feature vector corresponding to the first image block. The flattened pixel feature vector is then fused with the one-dimensional parameter feature vector with a size of 1*P. For example, the connection of the vectors is used as an example for fusion to obtain the fused feature vector with a size of 1*(P+NM). The fused feature vector is input into the neural network model for inference (the MLP network model shown in FIG. 9) to obtain the inpainted image. Flattening the multidimensional pixel feature vector can include the process of rearranging the matrix with N rows and M columns formed by the pixels included in the first image block into the matrix with one row or one column.

In some embodiments, the neural network model used to process the fused feature vector can be a perceptron model. Processing each fused feature vector through the neural network model to obtain the plurality of second image blocks corresponding to the plurality of first image blocks can include processing each fused feature vector through the perceptron model to obtain a plurality of second inpainted pixel feature vectors and rearranging each second inpainted pixel feature vector to obtain the plurality of second image blocks. The rearrangement process can be an inverse processing process of the rearrangement processing process.

As shown in FIG. 9, the output of the perceptron model (MLP) is a one-dimensional pixel feature vector. To obtain the second image block, the second inpainted pixel feature vectors may need to be rearranged. The process can include converting a matrix with one row or one column into a matrix with multiple rows and multiple columns, which is an inverse processing process of the previous matrix rearrangement process. For example, the output of the MLP network model in FIG. 9 is a one-dimensional pixel feature vector with a size of 1*(MN). To obtain the second image block, the one-dimensional pixel feature vector may need to be converted into a multidimensional pixel feature vector. The process can also be a process of converting Matrix (2) into Matrix (1).

In some embodiments, obtaining the inpainted image based on the plurality of second image blocks can include performing arrangement processing on the plurality of second image blocks according to the spatial positions to obtain the inpainted image corresponding to the to-be-inpainted image. Since the second inpainting is performed separately on each image block, each second image block obtained after the inpainting can be a part of the inpainted image. To obtain the complete inpainted image shown in FIG. 8, the plurality of second image blocks needs to be arranged to obtain the inpainted image corresponding to the to-be-inpainted image. in some embodiments, the method corresponding to the method of dividing the first inpainted image data can be used to arrange the plurality of second image blocks. For example, if the first inpainted image data is divided according to the spatial position, during the arrangement, the plurality of second image blocks can be arranged according to the spatial position. If the first inpainted image data is divided according to the number of rows and columns, during the arrangement, the plurality of second image blocks can be arranged according to the number of rows and columns.

In some embodiments, inpainting the to-be-inpainted image according to the parameter information and the pixel information to obtain the inpainted image can also include performing the first inpainting process on the to-be-inpainted image based on the pixel information of the to-be-inpainted image to obtain the first inpainting image data and performing a second inpainting process on the first inpainting image data based on the parameter information of the to-be-inpainted image to obtain the inpainted image corresponding to the to-be-inpainted image.

In embodiments of the present disclosure, the inpainting process of the to-be-inpainted image can include inpainting of two aspects, including the first inpainting based on the pixel information and the second inpainting based on the parameter information. For the to-be-inpainted image, when the inpainting effect of the first inpainting image data obtained by performing the first inpainting based on the pixel information is not enough, the second inpainting may need to be performed on the first inpainted image data based on the parameter information to cause the inpainted image to have a better inpainting effect. In embodiments of the present disclosure, the first inpainting process can be implemented in the above method based on the pixel feature vector, and the second inpainting process can be implemented in the above method based on the parameter feature vector. The first inpainting process and the second inpainting process can also be implemented in other methods, which is not limited to embodiments of the present disclosure.

The inpainting method of embodiments of the present disclosure can include performing inpainting on the to-be-inpainted image using the parameter information and the pixel information of the to-be-inpainted image to obtain the inpainted image. During the inpainting process, the pixel information and the parameter information of the to-be-inpainted image can be used simultaneously. Thus, the inpainted image obtained after inpainting can have a better inpainting effect.

In embodiments of the present disclosure, the to-be-inpainted image can also be a single frame image of a video file. That is, the method of the present disclosure can also be used to inpaint the video file. The inpainting of the video file can include inpainting each frame image of the video file. The inpainting processing process of the video file is described in connection with FIG. 10.

As shown in FIG. 10, for a video file collected using a certain hardware device, the parameter information of the video file can be the configuration file record of the hardware device, such as information recorded in an exchangeable image file. The parameter information can also be information recorded in other files that characterize the attributes of the video file. The information recorded in the exchangeable image file is taken as an example in FIG. 10. In the actual inpainting process, as shown in FIG. 10, the parameter information is obtained from the exchangeable image file. Then, according to the above method, the parameter information can be normalized to obtain the normalized parameter information, and the normalized parameter information can be input into the feature extraction network (the MLP neural network in FIG. 5) for inference to obtain the parameter feature vector corresponding to the video file. For the inpainting process of the video file, the video file can be divided into frames to obtain a plurality of single frame images, for example, a first frame image to an N-th frame image shown in FIG. 10. Then, the inpainting can be performed on each frame image to obtain the inpainted video file. The first frame image to the N-th frame image can have the same inpainting processing process. The N-th frame image can be taken as an example to describe the inpainting processing process of the first frame image to the N-th frame image.

For the N-th frame image, according to the processing method for the pixel information, the pixel information of the N-th frame image can be normalized and then input into the image inpainting network for the first inpainting process, which is the processing process shown in FIG. 6, to obtain the first inpainted image data. Then, the first inpainted image data can be divided into a plurality of first image blocks. The pixel feature vector of each first image block can be extracted. Then, the pixel feature vector of each first image block can be fused with the parameter feature vector corresponding to the video file to obtain a plurality of fused feature vectors. The plurality of fused feature vectors can be input into the neural network model (e.g., the MLP network model) for inference to obtain the inpainted N-th frame image. The same inpainting method can be performed on the other frame images, e.g., the first frame image to the (N−1)-th frame image to obtain the inpainted video file.

For a video segment, since the hardware device collecting the video is fixed, in some embodiments of the present disclosure, the parameter feature vector may only need to be extracted once for the video segment. The subsequent feature fusion process can use the same parameter feature vector. Since the pixel information of each frame image can be different, the pixel feature vector of each frame image may need to be extracted. Then, each frame image can be inpainted according to the parameter feature vector and the pixel feature vector of each frame image. In embodiments of the present disclosure, the neural network model can be a pre-trained model. As shown in FIG. 8, a training process for the neural network model is described.

As shown in FIG. 8, the neural network model of embodiments of the present disclosure includes a first neural network model, a second neural network model, and a third neural network model. In embodiments of the present disclosure, the first neural network model can be a CNN network model, and the second neural network model and the third neural network model can be MLP network models. In embodiments of the present disclosure, after creating the structure of the neural network model, during the model training, the first neural network model, the second neural network model, and the third neural network model can be trained simultaneously according to the pre-searched image data. That is, the training can be performed on the overall structure of the neural network model. After the first neural network model, the second neural network model, and the third neural network model output the expected effect, the neural network model structure required in embodiments of the present disclosure can be obtained. In some other embodiments, the model training process can include training the first neural network model (e.g., the CNN network model) first. The first neural network model can only be configured to perform pre-inpainting processing on the image according to the pixel information. After the first neural network model outputs the expected effect, the trained first neural network model can be grouped with the second neural network model and the third neural network model for training to reduce the training time and cause the neural network model structure required in embodiments of the present disclosure to have a better inpainting effect. The configuration adopted by the operations such as feature fusion and block division included in the image inpainting method can be consistent with the configuration adopted by the trained neural network model structure.

In some embodiments, according to the actual needs of different application scenarios, the neural network model structure shown in FIG. 8 is only used to inpaint a single image, a video file, or the single image and the video file simultaneously. In some embodiments, if the neural network model structure is only for inpainting the single image, the neural network model structure can only be trained based on the image data. If the neural network model structure is only for inpainting the video file, the neural network model structure can only be trained based on the video data. If the neural network model structure is for inpainting the single image and the video file simultaneously, the neural network model structure can be trained based on the image data and the video data. Thus, for different application scenarios, the user can select an appropriate training method to improve the model training efficiency and save the model training time. For the neural network model capable of inpainting the single image and the video file, in actual application, the neural network model may need to recognize the input object first and then switch the inpainting parameter corresponding to the neural network model according to the object type. In some embodiments, if the neural network model recognizes that the input object is a single image, the neural network model can switch the inpainting parameter to the parameter corresponding to image inpainting. If the neural network model recognizes that the input object is a video file, the neural network model can switch the inpainting parameter to the parameter corresponding to video file inpainting.

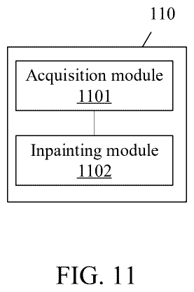

Based on the same concept, embodiments of the present disclosure also provide an inpainting apparatus. FIG. 11 illustrates a schematic structural diagram of the inpainting apparatus 110 according to some embodiments of the present disclosure. Apparatus 110 includes an acquisition module 1101 and an inpainting module 1102.

The acquisition module 1101 can be configured to obtain the parameter information and pixel information of the to-be-inpainted image. The parameter information can be used to represent the attribute of the to-be-inpainted image.

The inpainting module 1102 can be configured to perform inpainting processing on the to-be-inpainted image according to the parameter information and the pixel information to obtain the inpainted image.

In some embodiments, the inpainting module 1102 can be further configured to extract the pixel feature vector according to the pixel information, extract the parameter feature vector according to the parameter information, fuse the parameter feature vector and the pixel feature vector for processing by the neural network model to obtain the inpainted image.

In some embodiments, the inpainting module 1102 can be further configured to normalize the pixel information and parameter information to obtain the normalized pixel information and the normalized parameter information, obtain the pixel feature vector according to the normalized pixel information, and obtain the parameter feature vector according to the normalized parameter information.

In some embodiments, the inpainting module 1102 can be further configured to perform a first inpainting process on the to-be-inpainted image based on the pixel information of the to-be-inpainted image to obtain the first inpainted image data, divide the first inpainted image data into the plurality of first image block with an equal size according to the spatial position, and extract the pixel feature vector of each first image block.

In some embodiments, the inpainting module 1102 can be also configured to fuse the pixel feature vector corresponding to each first image block with the parameter feature vector to obtain the fused feature vector corresponding to each first image block, process each fused feature vector through the neural network model (e.g., the MLP network model) to obtain the plurality of second image blocks corresponding to the plurality of first image blocks, and obtain the inpainted image based on the plurality of second image blocks.

In some embodiments, the pixel feature vector corresponding to each first image block can be a multidimensional vector, Before fusing the pixel feature vector corresponding to each first image block with the parameter feature vector, the inpainting module 1102 can be further configured to perform rearrangement processing on each pixel feature vector to obtain the one-dimensional vector of each first image block with the same dimension as the parameter feature vector.

In some embodiments, the neural network model can be the perceptron model. The inpainting module 1102 can be further configured to process each fused feature vector through the perceptron model to obtain the plurality of second inpainted pixel feature vectors and rearrange each of the second inpainted pixel feature vectors to obtain the plurality of second image blocks. The rearrangement process can be an inverse process of the rearrangement processing process.

In some embodiments, the inpainting module 1102 can be also configured to perform the arrangement processing on the plurality of second image blocks according to the spatial position to obtain the inpainted image corresponding to the to-be-inpainted image.

In some embodiments, the inpainting module 1102 can be further configured to perform the first inpainting process on the to-be-inpainted image based on the pixel information of the to-be-inpainted image to obtain the first inpainted image data and perform the second inpainting process on the first inpainted image data based on the parameter information of the to-be-inpainted image to obtain the inpainted image corresponding to the to-be-inpainted image.

The description of device embodiments of the present disclosure is similar to the description of method embodiments above, and device embodiments have similar beneficial effects as method embodiments, which are not repeated here. For the technical details not described in device embodiments, reference can be made to the description of method embodiments.

In embodiments of the present disclosure, if the inpainting method is implemented in the form of a software functional module and sold or used as an independent product, the inpainting method can be stored in a computer-readable storage medium. Based on this understanding, the essence of the technical solution of embodiments of the present disclosure or the part contributing to the related technology can be embodied in the form of a software product. This computer software product can be stored in a storage medium and includes several instructions for causing a terminal to execute all or a part of the method described in embodiments of the present disclosure. The storage media can include USB drives, external hard drives, read-only memory (ROM), disks, or optical discs, and various media capable of storing program codes. Thus, embodiments of the present disclosure are not limited to any specific combination of hardware and software.

Embodiments of the present disclosure also provide an electronic device. The electronic device can include at least a processor and a computer-readable storage medium used to store executable instructions. The processor can be typically configured to control the overall operation of the electronic device. The computer-readable storage medium can be used to store instructions and applications that can be executed by the processor and cache data to be processed or already processed by various modules in the processor and the electronic device, which can be achieved through flash memory or random access memory (RAM). In some embodiments, the processor may be a neural network processor (NPU), a graphics processing unit (GPU), or another processor configured to perform neural network computations.

Embodiments of the present application provide a storage medium storing executable instructions that, when executed by the processor, cause the processor to perform the inpainting method of embodiments of the present disclosure.

In some embodiments, the storage medium can be a computer-readable storage medium, such as ferromagnetic random access memory (FRAM), read-only memory (ROM), programmable read-only memory (PROM), erasable programmable read-only memory (EPROM), electrically erasable programmable read-only memory (EEPROM), flash memory, magnetic surface memory, optical discs, or compact disk-read-only memory (CD-ROM), or various devices that include one or a combination of the above storage devices.

In some embodiments, the executable instructions can be in the form of programs, software, software modules, scripts, or codes written in any programming language (including compiled or interpreted languages, as well as declarative or procedural languages), and can be deployed in any form, including being deployed an independent program or as modules, assemblies, subroutines, or other units suitable for use in a computation environment.

For example, the executable instructions can but not necessarily correspond to files in the file system and can be stored as a part of a file that stores other programs or data. For example, the executable instructions can be stored in one or more scripts within a HyperText Markup Language (HTML) document, in a single file dedicated to the discussed program, or in multiple collaborative files (e.g., files storing one or more modules, subroutines, or code sections). For example, the executable instructions can be deployed on a computation device for execution, a plurality of computation devices in a same place for execution, or the plurality of computation devices distributed at a plurality of places and connected through the communication network for execution.

The technical features recorded in various embodiments of the present disclosure can be arbitrarily combined when there is no conflict.

The term “one embodiment” or “an embodiment” mentioned throughout the specification means that specific features, structures, or characteristics related to embodiments of the present disclosure are included in at least one embodiment of the present disclosure. Thus, the terms “in one embodiment” or “in an embodiment” appearing throughout the specification do not necessarily refer to the same embodiment. Moreover, these specific features, structures, or characteristics can be combined in any suitable manner in one or more embodiments. In embodiments of the present disclosure, the size of the numbers assigned to the processes above does not necessarily imply a specific order of execution. The execution order of the processes should be determined by their functionality and intrinsic logic, and should not limit the implementation process of embodiments of the present disclosure. The numbers assigned in embodiments of the present disclosure are for descriptive purposes only and do not represent the superiority or inferiority of the embodiments.

In the specification, the terms “comprise,” “include,” or any other variants are intended to cover non-exclusive inclusion, such that a process, method, or device comprising a series of elements not only includes those elements explicitly listed, but also includes other elements not explicitly listed that are inherent to such process, method, or device. Without further limitations, the phrase “comprising one . . . ” does not exclude the presence of other identical elements in the process, method, item, or device that includes the element. In some embodiments of the present disclosure, the disclosed devices and methods can be implemented in other methods. The device embodiments described above are illustrative only. For example, the division of units is only a logical functional division. In some other embodiments, other division methods can be adopted. For example, a plurality of units or assemblies can be combined or integrated into another system, or some features can be ignored or not executed.

The above are only some embodiments of the present disclosure. However, the scope of the present disclosure is not limited to this. Those skilled in the art can easily think of modifications or substitutions. The modifications and the substitutions should be within the scope of embodiments of the present disclosure. Therefore, the scope of the present application should be subject to the scope of the claims.

What is claimed is:

1. An inpainting method comprising:
obtaining parameter information and pixel information of a to-be-inpainted image, the parameter information characterizing an attribute of the to-be-inpainted image; and
performing inpainting processing on the to-be-inpainted image based on the parameter information and the pixel information to obtain an inpainted image.

2. The inpainting method according to claim 1, wherein performing the inpainting processing on the to-be-inpainted image based on the parameter information and the pixel information to obtain the inpainted image includes:
extracting a pixel feature vector according to the pixel information;
extracting a parameter feature vector according to the parameter information;
fusing the parameter feature vector with the pixel feature vector to obtain a fused feature vector; and
processing the fused feature vector through a neural network model to obtain the inpainted image.

3. The inpainting method according to claim 2, wherein extracting the pixel feature vector according to the pixel information and extracting the parameter feature vector according to the parameter information include:
normalizing the pixel information and the parameter information to obtain normalized pixel information and normalized parameter information; and
obtaining the pixel feature vector according to the normalized pixel information; and
obtaining the parameter feature vector according to the normalized parameter information.

4. The inpainting method according to claim 2, wherein extracting the pixel feature vector according to the pixel information includes:
performing a first inpainting process on the to-be-inpainted image based on the pixel information of the to-be-inpainted image to obtain first inpainted image data;
dividing the first inpainted image data into a plurality of first image blocks with an equal size according to a spatial position; and
extracting the pixel feature vector for each first image block.

5. The inpainting method according to claim 4, wherein fusing the parameter feature vector with the pixel feature vector to obtain the fused feature vector and processing the fused feature vector through the neural network model to obtain the inpainted image include:
fusing the pixel feature vector corresponding to each first image block with the parameter feature vector to obtain a fused feature vector for each first image block;
processing the fusion feature vector through the neural network model to obtain a plurality of second image blocks corresponding to the plurality of first image blocks; and
obtaining the inpainted image based on the plurality of second image blocks.

6. The inpainting method according to claim 5,
wherein the pixel feature vector corresponding to each first image block is a multidimensional vector,
before fusing the pixel feature vector corresponding to each first image block with the parameter feature vector, the method further comprising performing rearrangement processing on each pixel feature vector to obtain a one-dimensional vector of each first image block having a same dimension as the parameter feature vector.

7. The inpainting method according to claim 6, wherein the neural network model is a perceptron model, and processing the fusion feature vector through the neural network model to obtain the plurality of second image blocks corresponding to the plurality of first image blocks includes:
processing the fusion feature vector through the perceptron model to obtain a plurality of second inpainted pixel feature vectors;
rearranging the plurality of second restored pixel feature vectors to obtain the plurality of second image blocks, wherein a rearrangement process is an inverse of the rearrangement processing.

8. The inpainting method according to claim 5, wherein obtaining the inpainted image based on the plurality of second image blocks includes:
performing sorting processing on the plurality of second image blocks according to the spatial position to obtain the inpainted image corresponding to the to-be-inpainted image.

9. The inpainting method according to claim 1, wherein performing inpainting processing on the to-be-inpainted image according to the parameter information and the pixel information to obtain the inpainted image includes:
performing a first inpainting process on the to-be-inpainted image based on the pixel information of the to-be-inpainted image to obtain first restored image data; and
performing a second inpainting process on the first restored image data based on the parameter information of the to-be-inpainted image to obtain the inpainted image corresponding to the to-be-inpainted image.

10. An electronic device comprising:
a processor; and
a memory storing executable instructions that, when executed by the processor, cause the processor to:
obtain parameter information and pixel information of a to-be-inpainted image, the parameter information characterizing an attribute of the to-be-inpainted image; and
perform inpainting processing on the to-be-inpainted image based on the parameter information and the pixel information to obtain an inpainted image.

11. The device according to claim 10, wherein the processor is further configured to:
extract a pixel feature vector according to the pixel information;
extract a parameter feature vector according to the parameter information;
fuse the parameter feature vector with the pixel feature vector to obtain a fused feature vector; and
process the fused feature vector through a neural network model to obtain the inpainted image.

12. The device according to claim 11, wherein the processor is further configured to:
normalize the pixel information and the parameter information to obtain normalized pixel information and normalized parameter information;
obtain the pixel feature vector according to the normalized pixel information; and
obtain the parameter feature vector according to the normalized parameter information.

13. The device according to claim 11, wherein the processor is further configured to:
Perform a first inpainting process on the to-be-inpainted image based on the pixel information of the to-be-inpainted image to obtain first inpainted image data;
divide the first inpainted image data into a plurality of first image blocks with an equal size according to a spatial position; and
extract the pixel feature vector for each first image block.

14. The device according to claim 13, wherein the processor is further configured to:
fuse the pixel feature vector corresponding to each first image block with the parameter feature vector to obtain a fused feature vector for each first image block;
process the fusion feature vector through the neural network model to obtain a plurality of second image blocks corresponding to the plurality of first image blocks; and
obtain the inpainted image based on the plurality of second image blocks.

15. The device according to claim 14,
wherein the pixel feature vector corresponding to each first image block is a multidimensional vector,
before fusing the pixel feature vector corresponding to each first image block with the parameter feature vector, the processor is further configured to perform rearrangement processing on each pixel feature vector to obtain a one-dimensional vector of each first image block having a same dimension as the parameter feature vector.

16. The device according to claim 15, wherein the neural network model is a perceptron model, and the processor is further configured to:
process the fusion feature vector through the perceptron model to obtain a plurality of second inpainted pixel feature vectors; and
rearrange the plurality of second restored pixel feature vectors to obtain the plurality of second image blocks, wherein a rearrangement process is an inverse of the rearrangement processing.

17. The device according to claim 14, wherein the processor is further configured to:
perform sorting processing on the plurality of second image blocks according to the spatial position to obtain the inpainted image corresponding to the to-be-inpainted image.

18. The device according to claim 10, wherein the processor is further configured to:
perform a first inpainting process on the to-be-inpainted image based on the pixel information of the to-be-inpainted image to obtain first restored image data; and
perform a second inpainting process on the first restored image data based on the parameter information of the to-be-inpainted image to obtain the inpainted image corresponding to the to-be-inpainted image.

19. A computer-readable storage medium storing executable instructions that, when executed by a processor, cause the processor to:
obtain parameter information and pixel information of a to-be-inpainted image, the parameter information characterizing an attribute of the to-be-inpainted image; and
perform inpainting processing on the to-be-inpainted image based on the parameter information and the pixel information to obtain an inpainted image.

20. The storage medium to claim 19, wherein the processor is further configured to:
extract a pixel feature vector according to the pixel information;
extract a parameter feature vector according to the parameter information;
fuse the parameter feature vector with the pixel feature vector to obtain a fused feature vector; and
process the fused feature vector through a neural network model to obtain the inpainted image.
